(19) United States
(12) Patent Application Publication
(10) Pub. No.: US 2017/0070403 A1
(43) Pub. Date: Mar. 9, 2017

(54) USER TERMINAL, OPERATOR SERVER, REMOTE SUPPORT METHOD, AND PROGRAM FOR USER TERMINAL

(71) Applicant: OPTiM Corporation, Saga (JP)

(72) Inventor: Shunji SUGAYA, Tokyo (JP)

(21) Appl. No.: 14/845,496

(22) Filed: Sep. 4, 2015

(51) Int. Cl. H04L 12/24; H04M 15/00

(52) U.S. Cl. CPC H04L 41/5041; H04L 41/5087; H04L 41/5093; H04M 15/41

(57) ABSTRACT

The present invention is to provide a user terminal simply providing and receiving remote support to and from another user terminal to omit complex procedure such as user registration. The user terminal 150 receiving and providing remote support is capable of selecting and accessing a target user terminal 10 to receive remote support from the call log, the e-mail sent/received log, and the SMS sent/received log of the user terminal 150 to provide remote support to the user terminal 10 and capable of enabling the setting operation and the status viewing of not only the user terminal 10 which the user terminal 150 is accessing but also other devices communicatively connected with the user terminal 10.

### TECHNICAL FIELD

The present invention relates to a user terminal receiving and providing remote support based on a communication log, and an operator server, an operator system, and a remote support method, and a program for the user terminal.

### BACKGROUND ART

Recently, various services have been provided to users by connecting mobile terminals to web servers, etc. through a public network. In particular, the appearance of smart phones (high functional mobile phones) can provide mobile phones with advanced services provided to personal computers.

In addition to services provided from servers, smart phones themselves have various functions. However, it often takes time for users to become familiar with all the functions. For example, even if a smart phone has functions as the user desires, the user are not sure how to set up the functions, so that the user cannot utilize the functions.

In order to maximize the usage of such advanced web services and such advanced functions of smartphones, users need to be familiar with the setup operations and the functions of smartphones. Moreover if trying to setup the terminal for the first time, a user, who is not familiar with the setup operations of the user's terminal, may delete the setup information that should not be deleted or may end up an error because of the inappropriate configurations.

For approaching such problems, remotely supporting (maintaining) the users' terminals from the remote systems is known to configure the user's terminals and to instruct the users of the terminal. For example, Patent Document 1 discloses a server acquiring the screen information of a client to be supported and continuously displaying the screen information on the server to improve the support and monitoring efficiency of the client.

### CITATION LIST

### Patent Literature

Patent Document 1: JP 2003-6062A

Patent Document 2: JP 2011-034315 A

### SUMMARY OF INVENTION

In addition, it is known that remote operation is conducted by remotely logging in from a terminal providing remote support to a user terminal receiving support and sharing a screen in real time. Specifically, a screen being displayed on a user terminal is sequentially forwarded to and displayed on an operator terminal. This enables the operator terminal to perform input (remote) operation as if the user terminal is operated. In addition, Patent Document 2 discloses a method of conducting remote support by using a mobile phone.

However, the number of users who deal with sophisticated information devices have increased these days with the explosive growth of smart phones and personal computers. Therefore, the support time spent per person and the quality of support service are expected to be likely to decrease in inverse proportion to the number of users to one operator. Moreover, the remote support as described above allows an operator to freely operate individual devices. This makes users who are unfamiliar with information devices often unreasonably feel a sense of danger.

By the way, today, the traditional relationship between a company who provides services and a customer who receives the services has weakened because the system in which more customers provide and receive a service has been developed. In such a system, customers provide and receive services among themselves, and companies prepare the environment supporting the customers without directly providing services, so as to create their value.

The inventor has applied this system and noticed that a user receives remote support from another user but not from a business operator who provides remote support services to significantly increase the number of service providers. The inventor has also noticed that a user selects a terminal with which the user has already communicated from the communication logs as a terminal providing remote support to enhance the ease of selection and to reduce the privacy concerns and the crime risk, resulting in enhanced feeling of security during remote support.

Furthermore, when remotely logging on a device, an operator who operates an operator terminal may find that not the device but the devices connected therewith may have problems. For example, an operator needs to view and operate the SSID (Service Set Identifier) of the wireless router when connecting a smart phone with a domestic wireless LAN. Accordingly, logging on only a smart phone does not help so much.

The inventor has paid attention whether or not using a device (“smart phone” herein) to be supported enables devices communicatively connected therewith to be operated or viewed.

Accordingly, an objective of the present invention is to provide a user terminal receiving and providing remote support, which is capable of selecting and accessing a target user terminal to receive remote support from the call log, the e-mail sent/received log, and the SMS sent/received log of the user terminal to provide remote support to the target user terminal and capable of enabling the setting operation and the status viewing of not only the target user terminal which the user terminal is accessing but also other devices communicatively connected with the target user terminal and also to provide an operator server, a remote support method, and a program for the user terminal.

According to the first aspect of the present invention, a user terminal, as a target terminal, receiving remote support from another user terminal communicatively connected with the user terminal through a public network and, as an operator terminal, providing remote support to another user terminal communicatively connected with the user terminal through a public network, includes:

a log information acquisition unit acquiring at least one of a call log and an e-mail or SMS sent/received log as log information relating to one or more other user terminals;

a logged terminal selection unit selecting one or more other user terminals from the acquired log information; and

a remote support start unit starting remote support to the selected user terminals.

According to the first aspect of the present invention, a user terminal, as a target terminal, receiving remote support from another user terminal communicatively connected with the user terminal through a public network and, as an operator terminal, providing remote support to another user terminal communicatively connected with the user terminal through a public network, acquires at least one of a call log and an e-mail or SMS sent/received log as log information relating to one or more other user terminals, selects one or more other user terminals from the acquired log information, and starts remote support to the selected user terminal.

The first aspect of the present invention is the category of a user terminal, but the categories of a remote support method and a program for a user terminal have the same functions and effects.

According to the second aspect of the present invention, the user terminal according to the first aspect of the present invention further includes:

an electric appliance detection unit detecting an electric appliance connected with a user terminal through a local area network;

an electric appliance determination unit determining the model-related information of the detected electric appliance; and

an operator assistance unit enabling the setting operation or the status viewing of the electric appliance based on the determined model-related information.

According to the second aspect of the present invention, the user according to the first aspect of the present invention detects an electric appliance connected with the user terminal through a local area network, determines the model-related information of the detected electric appliance, and enables the setting operation or the status viewing of the electric appliance based on the determined model-related information.

According to the third aspect of the present invention, the user terminal according to the first or the second aspect of the present invention, in which the user terminal is communicatively connected with an operator server, and in the logged terminal selection unit, the log information is displayed in combination with information received from the operator server and indicates whether or not the other user terminals can receive remote support.

According to the third aspect of the present invention, the user terminal according to the first or the second aspect of the present invention is communicatively connected with an operator server, displays the log information in combination with information received from the operator server, and indicates whether or not the other user terminals can receive remote support.

According to the fourth aspect of the present invention, an operator server communicatively connected with the user terminal according to any one of the first to third aspects of the present invention includes a user terminal management database in a memory unit, in which

the user terminal administrative database associates and stores information indicating whether or not the other user terminals can receive remote support with information uniquely identifying the other user terminals.

According to the fifth aspect of the present invention, a remote support method executed by a user terminal, as a target terminal, receiving remote support from another user terminal communicatively connected with the user terminal through a public network and, as an operator terminal, providing remote support to another user terminal communicatively connected with the user terminal through a public network, includes the steps of

acquiring at least one of a call log and an e-mail or SMS sent/received log as log information relating to one or more other user terminals;

selecting one or more other user terminals from the acquired log information; and

starting remote support to the selected user terminal.

According to the sixth aspect of the present invention, a computer program product for use in a user terminal, as a target terminal, receiving remote support from another user terminal communicatively connected with the user terminal through a public network and, as an operator terminal, providing remote support to another user terminal communicatively connected with the user terminal through a public network, includes a non-transitory computer usable medium having a set of instructions physically embodied therein, the set of instructions including computer readable program code, which when executed by the user terminal causes the information processing unit to:

acquire at least one of a call log and an e-mail or SMS sent/received log as log information relating to one or more other user terminals;

select one or more other user terminals from the acquired log information; and

start remote support to the selected user terminal.

The present invention provides a user terminal receiving and providing remote support, which is capable of selecting and accessing a target user terminal to receive remote support from the call log, the e-mail sent/received log, and the SMS sent/received log of the user terminal to provide remote support to the target user terminal and capable of enabling the setting operation and the status viewing of not only the target user terminal which the user terminal is accessing but also other devices communicatively connected with the user terminal and also to provide an operator server, a remote support method, and a program for the user terminal.

### BRIEF DESCRIPTION OF DRAWINGS

FIG. 1 shows an overview of the remote support system 1.

FIG. 2 shows an overall schematic diagram of the remote support system 1.

FIG. 3 shows a functional block diagram of the operator server 200 and the user terminals 10 and 150.

FIG. 4 shows a flow chart illustrating the remote support process executed by the operator server 200 and the user terminals 10 and 150.

FIG. 5 shows a flow chart illustrating the remote support identification process executed by the operator server 200 and the user terminal 10.

FIG. 6 shows an example of the log information displayed on the user terminal 150.

FIG. 7 shows a screen image (network map screen) displayed on the user terminal 150.

FIG. 8 shows a screen image (network map screen with device status) displayed on the user terminal 150.

FIG. 9 shows an example of the setting page address list stored in the operator server 200.

FIG. 10 shows a flow chart illustrating the setting page acquisition process executed by the operator server 200, the user terminal 10, and the electric appliance 50.

FIG. 11 shows an example of the user terminal management table in the user terminal management database 250 provided in the operator server 200 to manage information on user terminals.

### DESCRIPTION OF EMBODIMENTS

Embodiments of the present invention are described below with reference to the attached drawings. However, this is illustrative only, and the scope of the present invention is not limited thereto.

### Overview of Remote Support System 1

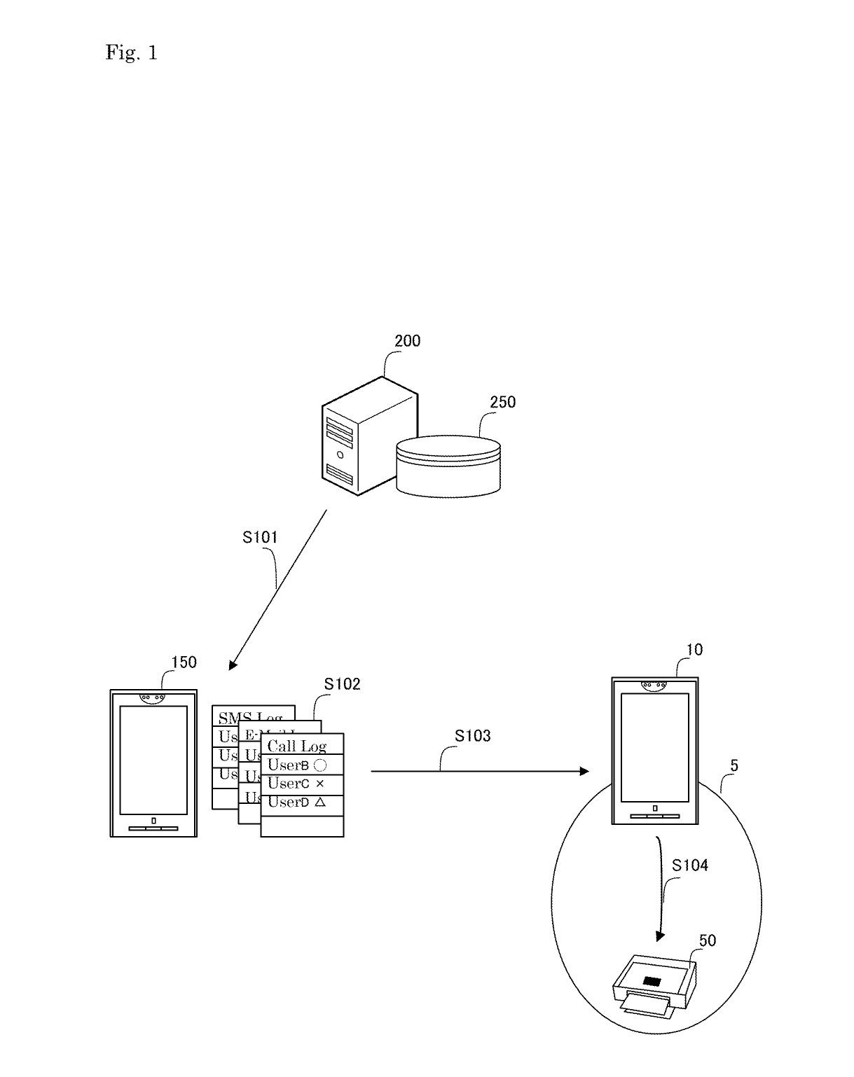

FIG. 1 shows an overall view of the remote support system 1 according to a preferred embodiment of the present invention. The overview is described below with reference to FIG. 1.

First, the user terminal 150 receives a list from the operator server 200. The list indicates whether or not other user terminals 10 can receive remote support (Step S101). The user terminals 10 to be supported are stored in a call log and an e-mail or SMS (short messaging service) sent/received log of the user terminal 150. At this timing, the user terminal 150 may transmit its status whether or not the user terminal 150 can provide remote support for other user terminals.

The user terminal 150 selects a user terminal 10 to which the user terminal 150 provides remote support, from the call log and the e-mail or SMS (short messaging service) sent/received log relating to other user terminals 10 (Step S102). These logs may be stored in a memory unit provided in the user terminal 150 or may be acquired from information stored in an external device, for example, an operator server 200. The status whether or not other user terminals 10 can receive remote support may be inquired through peer-to-peer communication as needed or may be centrally managed and maintained up-to-date by the user terminal management database 250 provided in the operator server 200.

The user terminal 150 transmits a remote support start request to the user terminal 10 (Step S103). This remote support start request is received by an application running on the user terminal 10 to ask the user whether or not to wish to start remote support. If the user selects the start, remote support is started. This remote support start request may be transmitted through not only application-specific communication based on a particular protocol but also e-mail or SMS (short messaging service) containing information on starting the application.

However, no application for remote support may have been installed in the user terminal 10. In this case, SMS, etc. containing information on installing the application, such as a download link, may be transmitted. Then, the application may be installed in the user terminal 10 based on the information.

The user terminal 150 can provide remote support to not only the user terminal 10 but also the electrical appliances 50 connected with the user terminal 10 (Step S104). The communication for remote support need not be conducted through the operator server 200 and may be done through peer-to-peer communication.

The above-mentioned procedure is explained when the user terminal 150 is taken as the starting point. In contrast, the procedure is the same as if the user terminal 10 is taken as the starting point.

### Configuration of Remote Support System 1

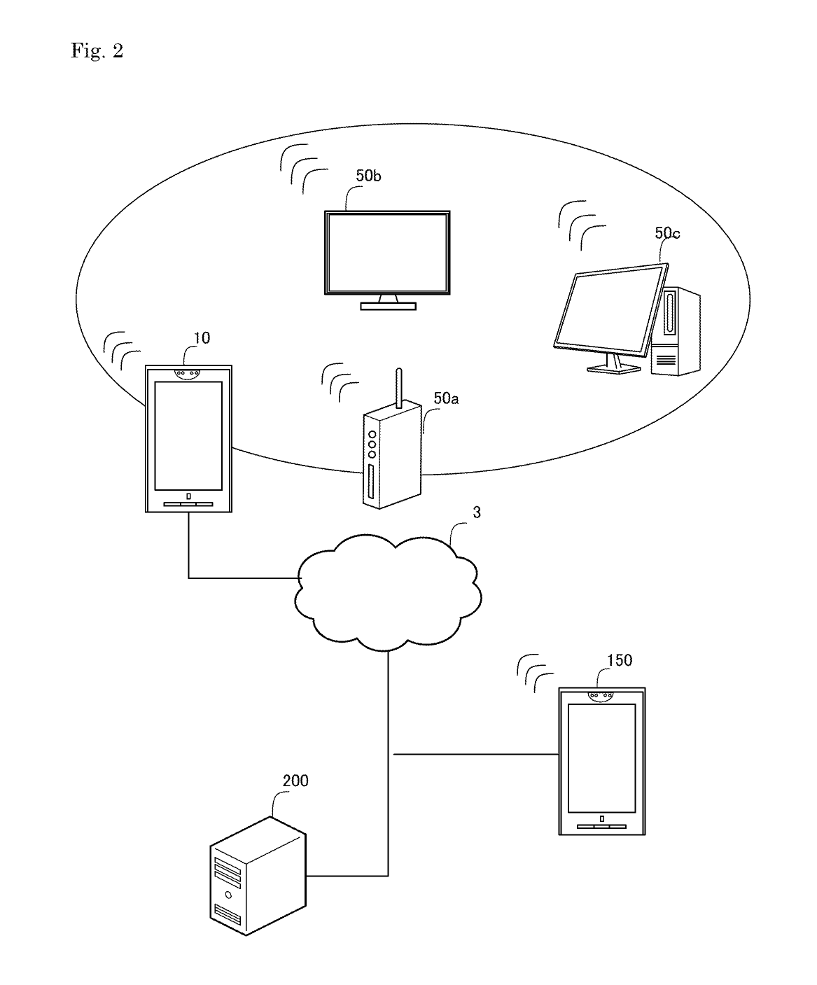

FIG. 2 shows a system configuration diagram of the remote support system 1 as a preferred embodiment of the present invention. The remote support system 1 includes the user terminal 10, the electric appliances 50a, 50b, and 50c (hereinafter simply referred to as “electric appliance terminal 50” unless otherwise specified), the operator server 200, a public line network 3 (e.g., Internet network, a third generation communication network, a fourth generation communication network), and the user terminal 150.

The user terminal 10 is communicatively connected with the operator server 200 through a public line network 3. The user terminal 10 is connected with each electric appliance 50 through a local area network (hereinafter referred to as “LAN”). The user terminal 10 is connected with the operator server 200 or the user terminal 150 through a public line network 3. The operator server 200 may be connected with the user terminal 150 through a local area network or a public line network 3. The communication in the remote support system 1 may be wired or unwired. The user terminal 10 may be communicatively connected with a public line network 3 through a network device such as a router.

The user terminal 10 may be a general information terminal for which a user receives or provides support, which is an information device or an electrical appliance with the functions to be described later. For example, the user terminal 10 may be a mobile phone, a smart phone 10b, a complex printer, a television 10a, a network device such as a router or a gateway, and a computer 10c. The user terminal 10 may also be white goods such as a refrigerator and a washing machine. The user terminal 10 may also be general information appliances such as a telephone, a netbook terminal, a slate terminal, an electronic book terminal, an electronic dictionary terminal, a portable music player, and a portable player and recorder.

The electric appliance 50 is a domestic or business appliance capable of data communication. Examples of the electric appliance include information appliances such as a personal computer 50c, a television 50b, a telephone, a computer, a mobile phone, a handheld terminal, a net book terminal, a slate terminal, an electronic book terminal, a portable music player, an audio component, a content player, a printer, a facsimile machine, a copy machine, a scanner, and an MFP (a multi-function peripheral device or a multi-function printer). Examples of the electric appliance also include white goods such as a refrigerator, a washing machine, a dishwasher, a fan, an air conditioner, an electric stove, a rice cooker, and a microwave oven. Examples of the electric appliance also include a light, a server, a router 50a, a gateway, and a network attached storage (hereinafter referred to as “NAS”).

The user terminal 150 may be a general information terminal with the functions to be described later like the user terminal 10, which means that the user terminal 150 is functionally the same as the user terminal 10. In this embodiment, the user of the user terminal 10 shall be different from that of the user terminal 150.

The operator server 200 manages the user terminals 10 and 150, relays data processing between the user terminals 10 and 150, and executes various processes. In this embodiment, the operator server 200 manages the user terminals 10 and 150 only. However, there is no upper limit for the number of user terminals managed by the operator server 200.

### Functions

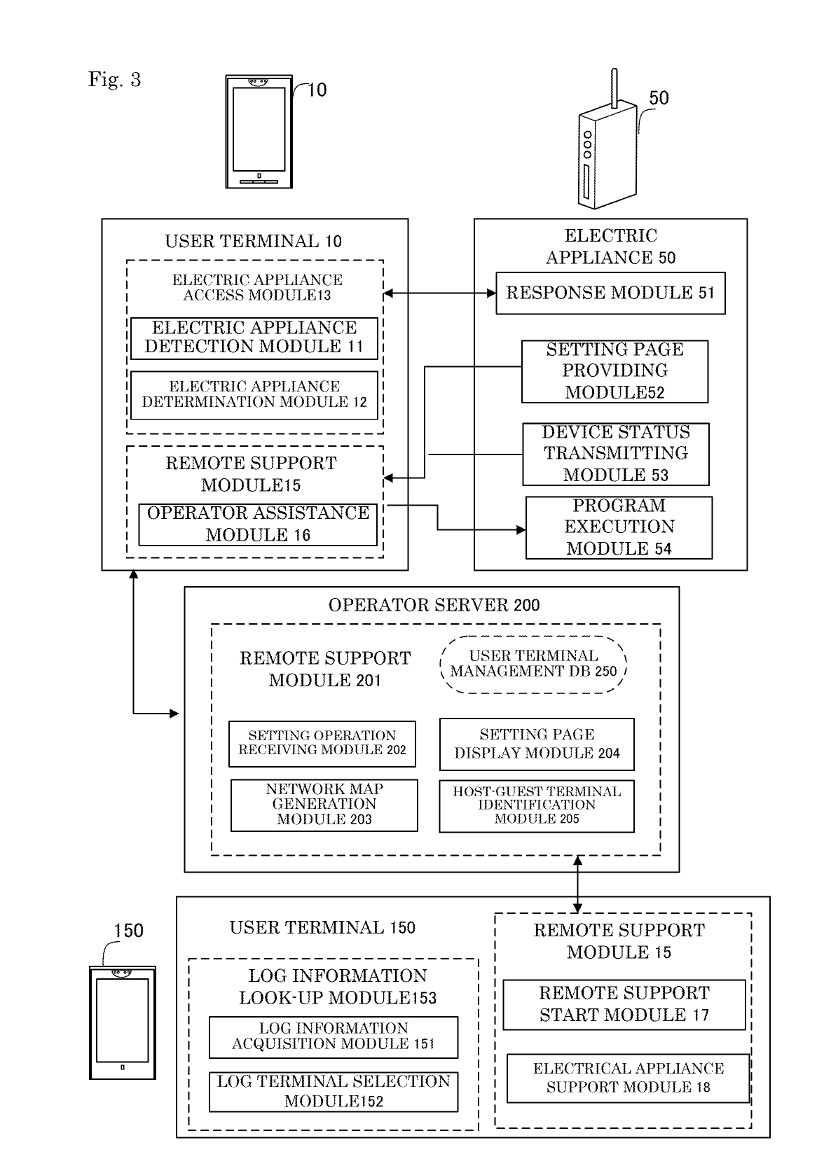

FIG. 3 shows the relationship among the respective functions of the user terminal 150, the operator server 200, and the user terminal 10. Each of the user terminals has the functions shown in FIG. 3 of the user terminals 10 and 150. Specifically, the functions described as those of the user terminal 10 have an effect on a target terminal that receives remote support while the function described as those of the user terminal 150 have an effect on an operator terminal that provides remote support. Therefore, the user terminals 10 and 150 have the respective functions of the target terminal and the operator terminal.

The user terminals 10 and 150 are provided with a control unit including a central processing unit (hereinafter referred to as “CPU”), a random access memory (hereinafter referred to as “RAM”), and a read only memory (hereinafter referred to as “ROM”); and a communication unit including Wireless Fidelity or Wi-Fi® enabled device complying with, for example, IEEE 802.11, a wireless device complying with the IMT-2000 standard such as the third generation mobile communication system. The communication unit may include a wired device for LAN connection.

The user terminals 10 and 150 are also provided with a display unit outputting and displaying data and images that have been controlled by the control unit as an output unit; and a touch panel, a keyboard, a mouse, etc., that receive input from a user and a supporter as an input unit. The user terminals 10 and 150 are also provided with a storage unit as a memory unit such as a hard disk or a semiconductor memory to store data. The user terminals 10 and 150 have a call log and an e-mail or SMS sent/received log relating to other user terminals in the memory unit.

In the user terminals 10 and 150, the control unit reads a predetermined program and cooperates with the communication unit, the output unit, the input unit, and the memory unit to achieve an electric appliance access module 13, a remote support module 15, and a log information look-up module 153. The electric appliance access module 13 is composed of an electric appliance detection module 11 detecting an electric appliance 50 communicatively connected with the user terminal 10 and an electric appliance determination module 12 determining the detected electric appliance 50. The remote support module 15 is composed of an operator assistance module 16 assisting in operator's operation, a remote support start module 17 starting remote support to a user terminal 10, and an electrical appliance support module 18 supporting the electrical appliance. The log information look-up module 153 is composed of a log information acquisition module 151 acquiring log information from the memory unit or other devices and a log terminal selection module 152 selecting a target terminal to receive a remote support from the log information.

In a similar way, the electric terminal 50 is provided with a control unit including a CPU, a RAM, and a ROM; and a communication unit including Wireless Fidelity or Wi-Fi® enabled device complying with, for example, IEEE 802.11, a wireless device complying with the IMT-2000 standard such as the third generation mobile communication system. The communication unit may include a wired device for LAN connection. The electric appliance 50 may also be provided with a storage unit such as a hard disk or a semiconductor memory to store data.

The electric appliance 50 may also be provided with a display unit outputting and displaying data and images that have been controlled by the control unit as an output unit; and a touch panel, a keyboard, a mouse, etc., that receive input from a user and an operator as an input unit.

In the electric appliance 50, the control unit reads a predetermined program and cooperates with the communication unit, the output unit, the input unit, and the memory unit to achieve a response module 51 responding to the packets transmitted from the user terminal 10, a setting page providing module 52 providing the setting page to be described later, a device status transmitting module 53 transmitting the device status of the electric appliance 50 to the user terminal 10, and a program execution module 54 executing a predetermined program.

In the similar way, the operator server 200 is provided with a control unit including a CPU, a RAM, and a ROM; and a communication unit including Wi-Fi® enabled device complying with, for example, IEEE 802.11. The operator server 200 is also provided with a storage unit as a memory unit such as a hard disk or a semiconductor memory to store data. The operator server 200 stores the user terminal management database 250 in the memory unit.

In the operator server 200, the control unit reads a predetermined program and cooperates with the communication unit and the memory unit to achieve a remote support module 201 allowing an operator to conduct remote support with the user terminal 150. The remote support module 201 is composed of a setting operation receiving module 202 receiving operation from the user terminal 150, a network map generation module 203 generating the network map of the local area network to which the user terminal 10 belongs, and a setting page display module 204 displaying the setting page to be described later, and a host-guest terminal identification module 205 identifying the host terminal and the guest terminal that are involved in the remote support.

### Remote Support Process

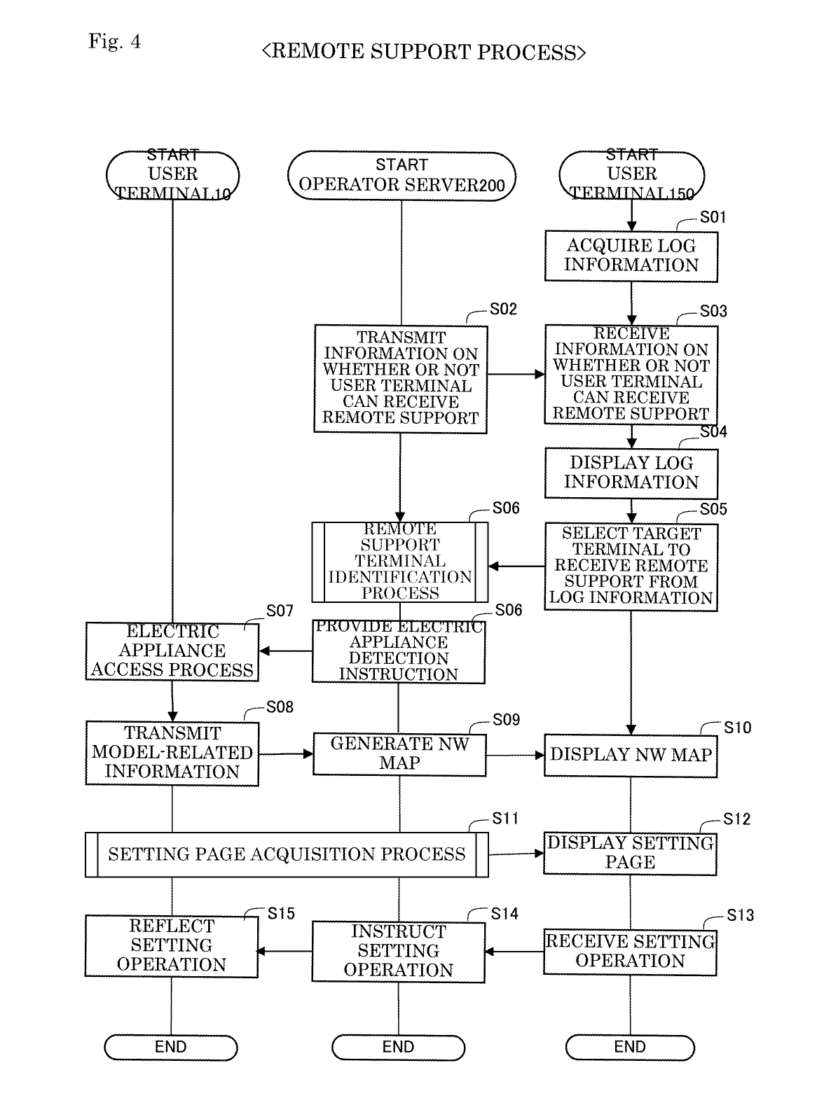

FIG. 4 shows a flow chart of the remote support process executed by the user terminal 10, the operator server 200, and the user terminal 150. The process executed by the modules of each of the above-mentioned devices will be explained together with this process.

First, the log information acquisition module 151 of the user terminal 150 acquires a call, an e-mail, and a SMS sent/received logs of the user terminal 150 (Step S01). These logs may be read from the memory unit of the user terminal 150 or may be acquired from information stored in an external device, for example, the operator server 200. Managing such logs in an external device, for example, a server is effective when the terminal is initialized after failure restoration, when the system is used from multiple different terminals, or when the amount of the log information is increased. SMS (short messaging service) is herein referred to a service transmitting electronic data such as characters, voices, images, and videos to other terminals based on information uniquely identifying the terminal, such as a phone number.

The remote support module 201 of the operator server 200 then transmits information on whether or not the user terminal 10 can receive remote support to the user terminal 150 (Step S02). The log information acquisition module 151 receives the information (Step S03). The user terminal 10 is one of terminals included in the acquired log. The user terminal 150 requests parameters associated with the information identifying a terminal included in the log from the operator server 200 to acquire a list of a plurality of terminals identified by the parameters that can receive remote support.

FIG. 11 shows an example of the user terminal management table in the user terminal management database 250 stored in the operator server 200 to manage information on user terminals. The user terminal management table associates and stores the phone number or the e-mail address of a terminal as a terminal ID with a user name, and an IP address, and information on whether or not the terminal can receives remote support. In this embodiment, “Y” in the application-installed column represents that the application has been installed, and “N” the application has not been installed. “Y” in the away-from-terminal column represents that the user is away from the terminal, and “N” the user is not. “NULL” is the table represents empty data.

The log terminal selection module 152 of the user terminal 150 combines and displays the acquired log information and the received information on whether or not the user terminal 10 can receive remote support in the display unit (Step S04). If receiving input from a user, then the log terminal selection module 152 selects a user terminal 10 from the displayed log information as a target terminal to receive remote support and notifies the operator server 200 of a remote support start request (Step S05).

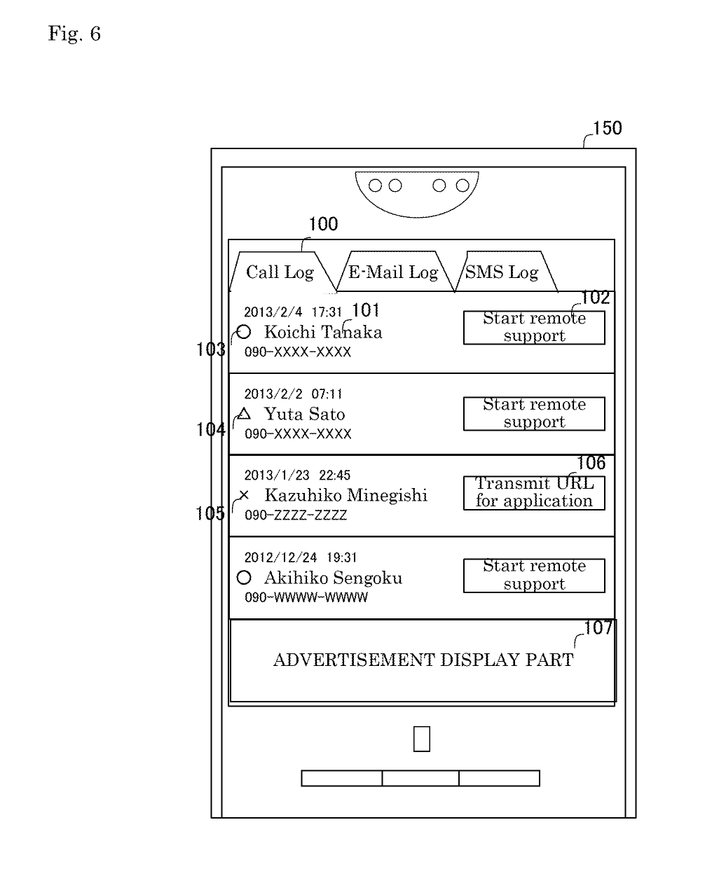

FIG. 6 shows an example screen showing the log information displayed on the user terminal 150. The log information is of three types: a call log, an e-mail log, and an SMS log. These three types are displayed with their respective tabs 100. In the log information, information 101 on a user name, etc. is displayed for each user. Remote support is started by pressing the start button 102 corresponding to a user. Moreover, information on whether or not the user can receive remote support is displayed for each user. A circle is displayed for a user who can receive remote support as the state 103 shows. A triangle is displayed for a user who hardly receives remote support as the state 104 shows because being away from the terminal. A cross is displayed for a user who cannot receive remote support as the state 105 shows because, for example, the application has not been installed. To the user who has not installed the application in the terminal, information for the installation of the application is transmitted by pressing the message transmission button 106. This screen may display an advertisement-displayed part 107.

The host-guest terminal identification module 205 of the operator server 200 performs the remote support terminal identification process to be described later and identifies the user terminal 10 as the target terminal to receive remote support and the user terminal 150 as the operator terminal (Step S06).

### Remote Support Terminal Identification Process

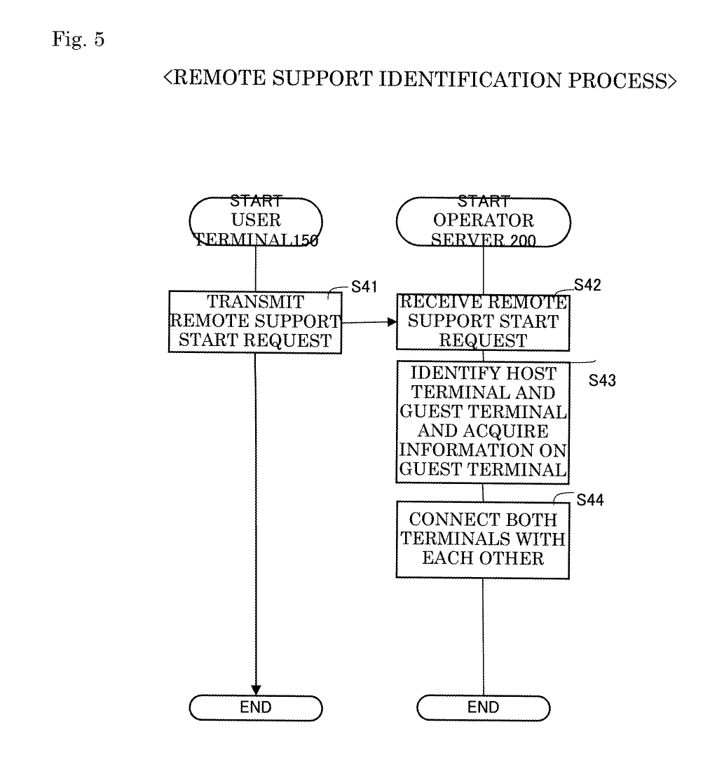

FIG. 5 shows a flow chart of the remote support process executed by the user terminal 150 and the operator server 200. The process executed by the modules performed by the above-mentioned devices will be explained together with this process.

First, the remote support module 15 of the user terminal 150 transmits a remote support start request to the operator server 200 (Step S41) as transmitting in the above-mentioned S05. The remote support start request from the user terminal 150 contains information on the user terminal 10, such as a phone number or an e-mail address. The remote support module 201 of the operator server 200 receives the remote support start request (Step S42).

The remote support module 201 reads information contained in the received remote support start request, identifies the user terminal 150 and the user terminal 10 as the operator terminal providing remote support and the terminal receiving remote support, respectively, and acquires information on the user terminal 10 (Step S43). The user terminal 150 may be an operator terminal and a target terminal to be supported and may identify itself when transmitting a remote support start request to the operator server 200. The case in which the user terminal 150 serves as an operator terminal is explained below.

The operator server 200 has the user terminal 10 log on the user terminal 150 to communicatively connect both the terminals with each other (Step S44). Like remote operation from an operator to a general terminal through remote login, the screen information being displayed on the display unit of the user terminal 10 may be viewed on the user terminal 150, or the user terminal 10 may be remotely operated from the user terminal 150.

This processing is especially effective when the operator server 200 unifies management of information on user terminals. When the user terminal 150 can be connected with the user terminal 10 through peer-to-peer communication, the above-mentioned remote support terminal identification process may be performed in the user terminal 150 or 10.

At this point, the user terminal 150 can execute the support process for the user terminal 10. For example, support information is displayed on the display unit of the user terminal 150. Specifically, user information on the user terminal 10 is output, and screen information being displayed on the display unit of the user terminal 10 is displayed.

However, an electric appliance 50 communicatively connected with the user terminal 10 may have a cause of failure while an operator is supporting the user terminal 10. For example, when the user terminal 10 cannot connect with the Internet, not the communication setting of the user terminal 10 but the setting of the router 50a as an electric appliance 50 may have a problem. The case in which there is viewing instruction of not the user terminal 10 on which the user terminal 150 has logged but an electrical appliance 50 is explained below.

The viewing instruction is received from an operator to show the operator the information on an electric appliance 50 communicatively connected with the user terminal 10. One example of the viewing instruction is the viewing instruction of the network map including the electric appliance 50. The viewing instruction of not only a network map but also the electric appliance 50 may be received.

The remote support module 201 of the operator server 200 then provides electric appliance detection instruction to the electric appliance access module 13 of the user terminal 10 (Step S06). The electric appliance detection instruction is a process to instruct the electric appliance detection module 11 of the user terminal 10 to detect the electric appliance 50 communicatively connected with the user terminal 10 through a local area network.

The electric appliance access module 13 of the user terminal 10 receives the electric appliance detection instruction from the operator server 200, and executes the electric appliance access process (Step S07). The electric appliance access process has the user terminal 10 transmit and receive a predetermined packet to determine the model-related information of the electric appliance 50. The model-related information is related to the device types such as the model name and the manufacturer name of an electric appliance 50. For this process, the process to determine the types of electric appliances connected with a network by transmitting and receiving a packet may be used, as described in JP 2010-97587 A.

The operator assistance module 16 of the user terminal 10 transmits the determined model-related information to the user terminal 150 and the operator server 200 (Step S08). When model⁻related information is determined for each of a plurality of electric appliances 50, the model-related information of the individual electric appliances 50 is transmitted.

The network map generation module 203 of the operator server 200 generates a network map based on the model-related information (Step S09). In the operator server 200, an icon for the electric appliance (hereinafter referred to as “electric appliance icon”) displayed on a network map is associated with the model-related information and stored, previously. The corresponding electric appliance icon is extracted based on the received model-related information to generate a network map. Furthermore, the local area network connected with the electric appliances 50 represents a circle or the like. Cloud icons are used for a public line network 3 connected with the electric appliances 50. The operator server 200 transmits the generated network map to the user terminal 150.

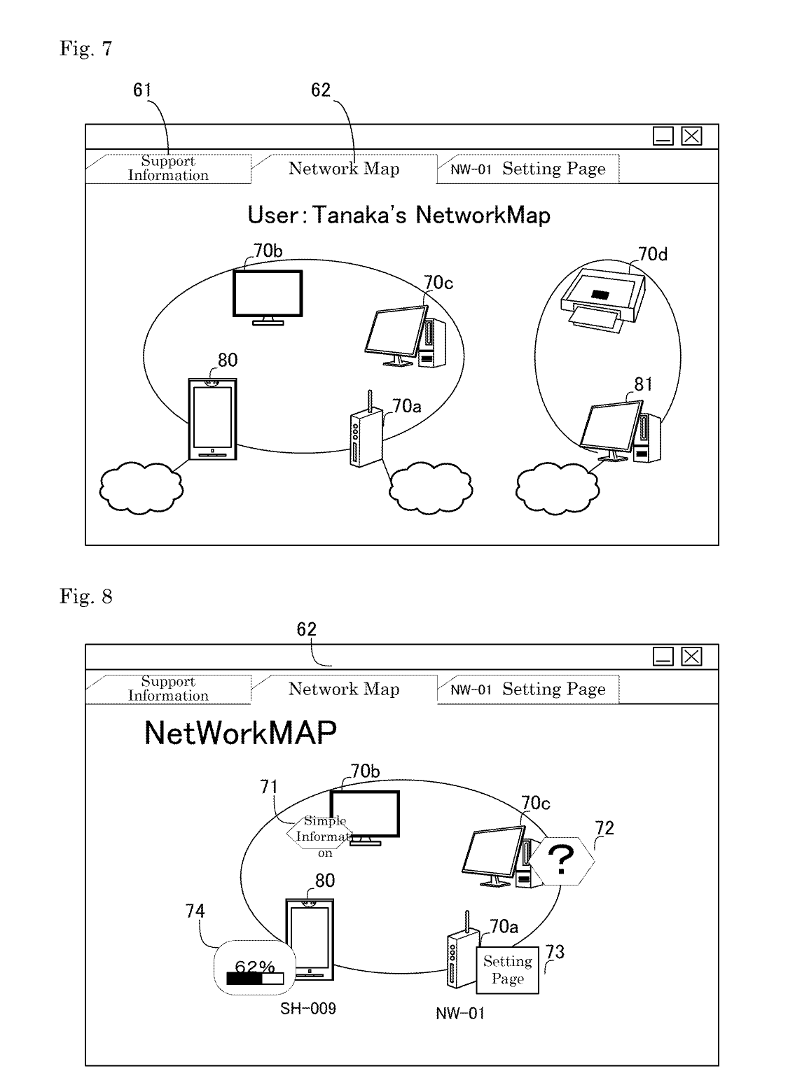

The remote support module 15 of the operator terminal 150 receives and displays the received network map (Step S10). As one example, the network map is made up as shown in FIG. 7. The remote support window of the user terminal 150 is provided with multiple window tabs of the support information 61 and the network map 62. The support information 61 and the network map 62 can be selected from an operator for display. The network map is displayed with electric appliance icons 70a to 70d. For example, the model-related information of the router 50a is determined as “NW-01,” and the electric appliance icon 70a corresponding thereto is displayed. The user terminal 10 may be represented by an icon 80.

If two or more independent local area networks exist, network icons 80 and 81 are displayed as shown in FIG. 7. In this case, if wishing to remotely support the printer represented by the icon 70d, an operator should have the user terminal 150 log on not the user terminal 10 represented by the icon 80 but the user terminal 10 represented by the icon 81.

The device status of each of the electric appliances 50 and the user terminal 10 may be displayed around the icon of the corresponding device on the network map as shown in FIG. 8. The device status is information on a device, for example, the failure situation, the executing state of a program, etc., the program installation status, and the presence or absence of the setting page to be described later of an electric appliance 50, and simple information describing an electric appliance 50. In the setting page to be described later, the device status includes the setting status of an electric appliance 50.

For example, the user terminal 10 may not able to determine the model-related information even after detecting the electric appliance 50. In this case, an undetermined icon 72 is displayed near the electric appliance icon 70c to show the failure in which the model-related information of the electric appliance 50 was not able to be determined. Alternatively, information acquired from the electric appliance 50 from a transmitted request packet is displayed as simple information instead of model-related information. For example, the icon 71 indicating the presence of simple information or the simple information itself is displayed on a network map.

The device status may be acquired by using the device status transmitting module 53 which is a program previously installed in an electric appliance 50. The device status transmitting module 53 acquires and transmits the device status of an electric appliance 50 to the user terminal 10 periodically.

On the other hand, when a setting page corresponding to the electric appliance 50 exists, a setting page icon 73 is displayed, as described below. Furthermore, when a predetermined program is executed or installed in an electric appliance 50, a graph indicating the progress of the installation and the execution is displayed as an icon 81.

### Setting Page Acquisition Process

The operator server 200, the user terminal 10, and the electric appliance 50 then execute the setting page acquisition process (Step S11).

The setting page is a web page provided by an electric appliance 50, which enables the status viewing and the setting operation of the electric appliance 50. For example, a router 50a itself functions as a local web server, so that the setting page of the router 50a can be input and viewed from other devices.

Specifically, the router 50a detects the event that the URL address or the IP address provided from this router 50a as a private address is input to the web browser of a personal computer 50c communicatively connected with the router 50a through a local area network, and then displays the setting page on the web browser of the personal computer 50c. A user can view and input the setting page through the web browser. Generally, the setting page cannot be viewed and input from a device (with only a global address) connected through a public line network 3, as described below.

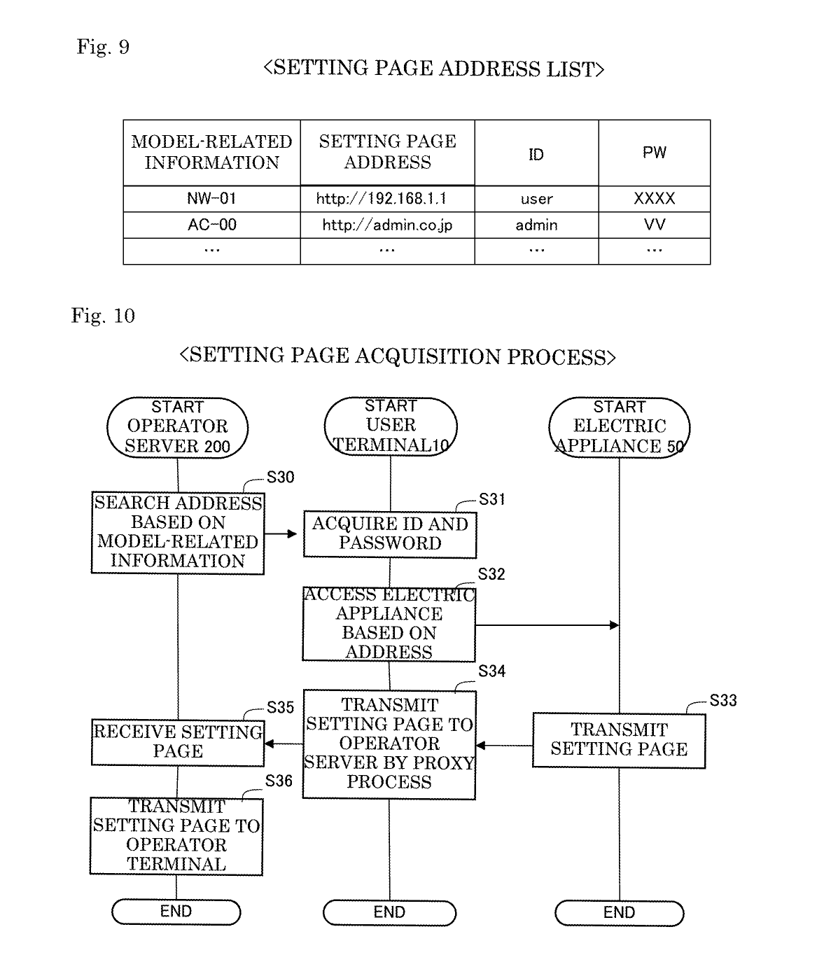

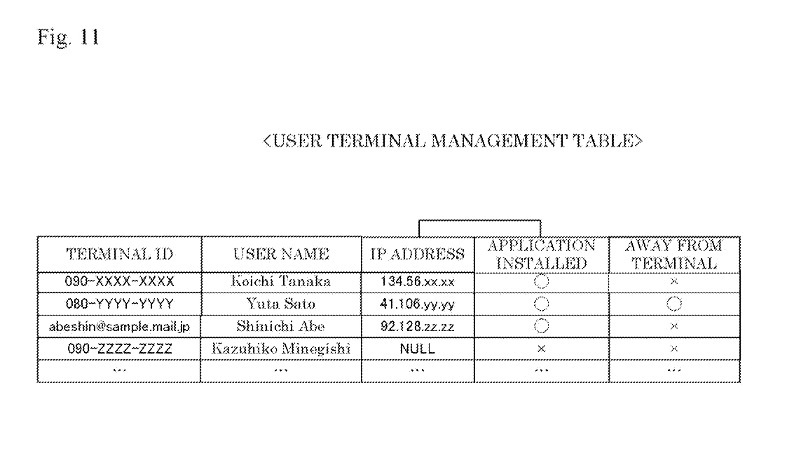

The setting page display module 204 of the operator server 200 first looks up to the setting page address list as shown in FIG. 9 and searches a setting page address based on the model-related information transmitted from the user terminal 10 (Step S30). In the setting page address list, the model-related information is associated with the URL address or the IP address of a setting page. For example, when the model-related information is “NW-01,” the setting page address is “http://192.168.1.1.”

As shown in FIG. 9, the model-related information may be associated with the URL address or the IP address of a setting page as well as the ID and the password to view and input the setting page. The ID and the password are set in an electric appliance 50 by default, which may be described in the manual, etc. These described in the manual, etc. enable a user to view and input the setting page even if the user does not know the default ID and the password.

The setting operation receiving module 202 of the operator server 200 transmits the setting page address to the user terminal 10. When stored in the setting page address list, the ID and the password are transmitted as well. In this case, the next step S31 is not executed.

When the ID or the password is not stored in the setting page address list, the setting page providing module 52 of the user terminal 10 acquires the ID and the password stored in the user terminal 10 (Step S31). In other words, a user stores the ID and the password of the setting page in the user terminal 10.

The operator assistance module 16 of the user terminal 10 accesses the electric appliance 50 based on the received setting page address (Step S32). In response to this, the setting page providing module 52 of the electric appliance 50 functions as a web server, and transmits the setting page to the user terminal 10 (Step S33). When receiving the setting page, the user terminal 10 inputs the acquired ID and password, responds to the electric appliance 50, and executes a process to log on the setting page.

The user terminal 10 then transmits the setting page to the operator server 200 by the proxy process (Step S34). For example, an electric appliance 50 is connected with the user terminal 10 through a local area network. The electric appliance 50 has a private address (192.168.1.1), and the user terminal 10 has a private address (192.168.1.50). The setting page data is transmitted as the data A of the source, which is the electric appliance 50, to the user terminal 10 through the private addresses.

On the other hand, the user terminal 10 is connected with the operator server 200 through a public line network 3, i.e., global addresses. The user terminal 10 has a global address (210.0.0.218), and the operator server 200 has a global address (210.0.0.1). The user terminal 10 changes the source from the electric appliance 50 to the user terminal 10 and transmits the data A as the data B to the operator server 200 through the global addresses.

The operator server 200 receives the setting page by this proxy process (Step S35) and transmits the setting page to the user terminal 150 (Step S36).

The process is returned to the remote support process shown in FIG. 4, and the user terminal 150 displays the received setting page (Step S12). This setting page enables the status viewing and the setting operation of a router 50a. For example, the status viewing and the setting operation of “Wireless LAN access point setting,” “SSID setting,” etc., of a router 50a are enabled.

As described above, the viewing of a setting page is enabled by the proxy process executed by the user terminal 10, but may be enabled by the screen transfer function achieved by the operator assistance module 16 of the user terminal 10. Specifically, when a setting page can be viewed and input from the user terminal 10, the screen information is transferred to the operator server 200. The screen information is transmitted as data to the operator server 200, so that the setting page may merely be transferred without the setting page displayed on the user terminal 10. Furthermore, the input information is transmitted from the user terminal 150 to an electric appliance 50 through the user terminal 10 to enable the setting operation.

A program may be installed in an electric appliance 50, and a command to set predetermined data may be received from the operator server 200 and executed in an electric appliance 50 through the user terminal 10. Specifically, the user terminal 150 receives the installation of a predetermined program and the setting of data from an operator for the electric appliance icons of a network map displayed on the operator terminal 150, and then the operator server 200 transmits a predetermined command to electric appliances 50 corresponding to the electric appliance icons.

In this case, the operator server 200 may receive a program to be installed from other servers, or may transmit a command to allow an electric appliance 50 to download a program. The command to set predetermined data may be previously stored in the operator server 200. When the electric appliance 50 is, for example, a printer, the command to set predetermined data may be a switch between monochrome and color prints.

If the user terminal 150 simultaneously receives the designation of a plurality of electric appliances 50 displayed on a network map from an operator, a predetermined program may be installed in the electric appliances 50.

The above-mentioned procedure is explained when the user terminal 150 is taken as the starting point. In contrast, the procedure is the same as if the user terminal 10 is taken as the starting point.

To achieve the means and the functions that are described above, a computer (including CPU, an information processor, and various terminals) reads and executes a predetermined program. For example, a program is provided in a form recorded in a computer-readable recording medium such as a flexible disk, a CD (e.g., CD-ROM), and a DVD (e.g., DVD-ROM and DVD-RAM). In this case, a computer reads a program from the recording medium, forwards and stores the program to and in an internal or an external storage, and executes it. For example, the program may be previously recorded in a memory (a record medium) such as a magnetic disk, an optical disk, and a magnetic optical disk, and then provided from the memory to the computer through a communication line.

The embodiments of the present invention are described above. However, the present invention is not limited to these embodiments. In addition, the effects described in these embodiments merely illustrate the most preferable effects resulting from the present invention, and the effects of the present invention are not limited to those described in these embodiments

### REFERENCE SIGNS LIST

1 Remote support system

3 Public network

10 User terminal

200 Operator server

150 User terminal

What is claimed is:

1. A user terminal, as a target terminal, receiving remote support from another user terminal communicatively connected with the user terminal through a public network and, as an operator terminal, providing remote support to another user terminal communicatively connected with the user terminal through a public network, comprising:
a log information acquisition unit acquiring at least one of a call log and an e-mail or SMS sent/received log as log information relating to one or more other user terminals;
a logged terminal selection unit selecting one or more other user terminals from the acquired log information; and
a remote support start unit starting remote support to the selected user terminals.

2. The user terminal according to claim 1, further comprising:
an electric appliance detection unit detecting an electric appliance connected with a user terminal through a local area network;
an electric appliance determination unit determining the model-related information of the detected electric appliance; and
an operator assistance unit enabling the setting operation or the status viewing of the electric appliance based on the determined model-related information.

3. The user terminal according to claim 2, wherein the user terminal is communicatively connected with an operator server, and in the logged terminal selection unit, the log information is displayed in combination with information received from the operator server and indicates whether or not the other user terminals can receive remote support.

4. The user terminal according to claim 1, wherein the user terminal is communicatively connected with an operator server, and in the logged terminal selection unit, the log information is displayed in combination with information received from the operator server and indicates whether or not the other user terminals can receive remote support.

5. An operator server communicatively connected with the user terminal according to claim 1, comprising a user terminal management database in a memory unit, wherein
the user terminal administrative database associates and stores information indicating whether or not the other user terminals can receive remote support with information uniquely identifying the other user terminals.

6. A remote support method executed by a user terminal, as a target terminal, receiving remote support from another user terminal communicatively connected with the user terminal through a public network and, as an operator terminal, providing remote support to another user terminal communicatively connected with the user terminal through a public network, comprising the steps of:
acquiring at least one of a call log and an e-mail or SMS sent/received log as log information relating to one or more other user terminals;
selecting one or more other user terminals from the acquired log information; and
starting remote support to the selected user terminal.

7. A computer program product for use in a user terminal, as a target terminal, receiving remote support from another user terminal communicatively connected with the user terminal through a public network and, as an operator terminal, providing remote support to another user terminal communicatively connected with the user terminal through a public network, comprising a non-transitory computer usable medium having a set of instructions physically embodied therein, the set of instructions including computer readable program code, which when executed by the user terminal causes the information processing unit to:
acquire at least one of a call log and an e-mail or SMS sent/received log as log information relating to one or more other user terminals;
select one or more other user terminals from the acquired log information; and
start remote support to the selected user terminal.
